(19) United States
(12) Patent Application Publication
(10) Pub. No.: US 2020/0400539 A1
(43) Pub. Date: Dec. 24, 2020

(54) SOIL DRYER

(71) Applicant: AgriCORE LLC, New Haven, CT (US)

(72) Inventors: Seila Vanessa DE LEON, Miami Beach, FL (US); Natalie Simon IRWIN, Concord, NH (US)

(21) Appl. No.: 16/906,202

(22) Filed: Jun. 19, 2020

Related U.S. Application Data
(60) Provisional application No. 62/863,366, filed on Jun. 19, 2019.

(51) Int. Cl. G01N 1/44; F26B 9/00

(52) U.S. Cl. CPC G01N 1/44; F26B 9/003

(57) ABSTRACT

A soil dryer is provided that allows a user to efficiently decrease the moisture content of a small soil sample to a level of five percent or less at the site of sample collection without needing an external source of power or electricity or jeopardizing the carbon content of the sample.

### CROSS-REFERENCE TO RELATED APPLICATIONS

This application claims the benefit of U.S. Provisional Patent Application 62/863,366, filed Jun. 19, 2019, entitled “SOIL DRYER” the content of which is incorporated by reference herein in its entirety.

### FIELD OF THE DISCLOSURE

The present disclosure is directed to a soil drying device that provides a dry sample of soil (defined for most soil analysis purposes as having a water content equal to or less than five percent moisture) at the source of soil sampling and without jeopardizing the carbon content of the sample.

### BACKGROUND OF THE DISCLOSURE

As disclosed herein, currently available drying methods for soil include drying in large, laboratory-grade ovens, and drying in standard microwaves that have been electrically connected to vehicle batteries near a sampling site. These prior art methods are not feasible for use in areas that are not easily accessible by road, as only the microwave method can be used at the location of sampling, and only if that location is near enough a road.

Additionally, conventional methods are also not feasible for use at the site of soil sampling, as both methods require large amounts of power, with the microwaves powered by vehicle batteries, and the laboratory-grade ovens powered by the electricity accessible in laboratory buildings. Lastly, these conventional methods risk jeopardizing the soil carbon content if samples are exposed to sufficiently high temperatures for too long. The drying of samples with laboratory-grade ovens is the only currently available method which allows specific temperatures to be set for drying, but that method often takes between 16 and 48 hours to do so. No currently available method allows for dry soil sample analysis to take place efficiently and on site due to at least these feasibility issues.

Based on the foregoing, there is a need for a device to dry soil samples at the location of sampling in order to perform analyses on the soil. These analyses (carbon content analysis in particular) are used to evaluate and manage land. Carbon content analysis is important because it indicates the fertility of the soil and hence is integral for sustainable land management practices. This soil analysis cannot be accurately performed using light spectrometry unless soil samples are dry, allowing the genuine color of the soil to be observed and analyzed. Light spectrometry determines carbon content of soil by analyzing the color of the soil, hence the genuine color of the soil is integral to the accuracy of this method.

There is a need for a technology that allows drying to be performed quickly, easily, and at the site of sampling, without the risk of jeopardizing the carbon content of the sample. Wherefore it is an object of the present disclosure to overcome the above-mentioned shortcomings and drawbacks associated with the conventional soil drying systems.

### SUMMARY OF THE DISCLOSURE

One aspect of the present disclosure is a soil dryer assembly for removing moisture content from soil sampled from a ground, the soil dryer assembly comprising: a containment box configured to hold and mount dryer mechanical and electrical components; an air chamber lined with insulation, and attached to a fan at a narrow opening covered by a vented lid at a widened opening, the fan being secured onto the narrow opening of the air chamber; one or more heating pads regulated by a thermocouple; an LCD that displays a temperature measured and reported by the thermocouple; a first power source comprising batteries in parallel, controlled by a general power switch and powering the fan, the LCD, and the thermocouple; a second power source comprising another battery to power the one or more heating pads lining the inner air chamber.

One embodiment of the soil dryer is wherein a user dries a sample of soil to a moisture content of five percent or less at the site of sampling. In some embodiments, insulation is inside and outside of the air chamber.

Another embodiment of the soil dryer is wherein the vented lid is held in place by magnets. In some cases, the air chamber is configured to fit a soil sample in a Petri dish.

Yet another embodiment of the soil dryer is wherein a heat conducting plate is used to support the soil sample in the air chamber and provide for even heating of the sample. In some cases, the heating pads are coded to reach about 200 degrees Celsius.

Still yet another embodiment of the soil dryer is wherein the first power source is 3 9V batteries, and the second power source is a drill battery.

Another aspect of the present disclosure is a method for removing moisture content from soil sampled from a ground, the method comprising: providing a soil drying device comprising: a containment box configured to hold and mount dryer mechanical and electrical components; an air chamber lined with insulation, and attached to a fan at a first opening covered by a vented lid at a second opening, the fan being secured onto the first opening of the air chamber; one or more heating pads regulated by a thermocouple; an LCD that displays a temperature measured and reported by the thermocouple; a first power source comprising batteries in parallel, controlled by a general power switch and powering the fan, the LCD, and the thermocouple; and a second power source comprising another battery to power the one or more heating pads lining the inner air chamber; switching on the general power and a heater switch; waiting for the temperature in the air chamber to reach a threshold temperature; removing the vented lid and placing a soil sample inside the air chamber; replacing the vented air lid; waiting for a time period in minutes; and removing the sample for further analysis, wherein the moisture content of the sample is five percent or less at the site of sampling.

One embodiment of the method is wherein insulation is inside and outside of the air chamber.

Another embodiment of the method is wherein the vented lid is held in place by magnets. In some cases, the air chamber is configured to fit a soil sample in a Petri dish.

In certain embodiments of the method, a heat conducting plate is used to support the soil sample in the air chamber and provide for even heating of the sample. In some cases, the heating pads are coded to reach about 200 degrees Celsius.

Yet another embodiment of the method is wherein the first power source is 3 9V batteries, and the second power source is a drill battery.

Still yet another embodiment of the method is wherein second power source is a higher voltage than the first power source which is portable and rechargeable source and powers only the heating pads.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows an exploded view of one embodiment of a soil dryer of the present disclosure.

FIG. 2 shows axonometric view of one embodiment of an air chamber according to the principles of the present disclosure.

FIG. 3 shows a front axonometric view of one embodiment of the soil dryer of the present disclosure where a lid, switches, and LCD are visible.

FIG. 4 shows a transparent front axonometric view of one embodiment of the external enclosure of a soil dryer of the present disclosure.

FIG. 5 shows a transparent front axonometric view of one embodiment of the soil dryer of the present disclosure.

FIG. 6 shows a transparent front axonometric view of one embodiment of the soil dryer of the present disclosure as in FIG. 5, with added electronic boards.

FIG. 7 shows an exploded transparent view of one embodiment of a soil dryer of the present disclosure similar to FIG. 1.

FIG. 8 shows a schematic diagram of one embodiment of a soil dryer of the present disclosure with power and ground electrical connections.

### DETAILED DESCRIPTION OF THE DISCLOSURE

There is disclosed herein a soil dryer assembly for removing moisture content of soil taken from the ground. The soil dryer assembly is powered by a battery. In one embodiment it is a battery similar to that of a battery used in a portable drill, (e.g., a 20-volt, 6-amp drill battery) making it portable. One embodiment of the soil dryer device includes a small box that is machined to contain all components of the drying method and into which a drill battery, or the like, can be inserted as the central power supply. In one embodiment, the battery is inserted into the bottom of the box, similar to how it would slide in to and out of position on a portable drill handle. An air chamber spans the width of the box from front to back, and has a vented lid attached at the wide end of the air chamber and a small fan attached at the opposite, narrow opening of the air chamber.

In certain embodiments, the vented lid is removable, allowing easy access to the air chamber for insertion of petri dishes, or the like, containing soil samples. In some cases, the vented lid is held on by magnets, which are attached to indentations in the lid, and attracted to magnets that have been attached to the inside of the dryer box with adhesive, or the like. A fan is screwed directly to the air chamber, allowing it to remain fixed at all times. When powered on, the fan runs at full speed for three of every ten seconds. The fan is connected to a power switch and a SparkFun Redboard, or the like, via a 2N transistor. A power switch connects to three 9-volt batteries connected in parallel. The 9-volt batteries are contained within the box, but have barrel jack connectors that feed out of a machined hole in the side of the dryer box. In one embodiment, these connectors are plugged into a standard, three battery recharging port. This allows the 9-volt batteries to be recharged by simply plugging in the recharging station on the side of the box into a standard outlet. The user never has to open up the box to reveal electronics or retrieve the rechargeable batteries.

The air chamber into which the petri dish is inserted is lined both inside and outside with insulation bubble wrap foil, or similar material. There are also two heating pads that line the air chamber, one of which lines the top and sides of the chamber, and the other which is folded in half to line only the bottom of the chamber. These heating pads are wired in series, and are soldered to a Tip 120 transistor on one end, and a power switch exclusive to the heaters on the other end. The wires are fed through a small hole in the air chamber, which leads to the area of the box containing all electrical components, which is external to the air chamber, denying customers access to the electronics. The Tip 120 transistor connects the heating pads to the SparkFun Redboard, or the like, to which the code for the dryer is uploaded, as well as the drill battery, which powers the heating pads exclusively.

On top of the heating pad lining the air chamber's bottom, there is an aluminum plate of a thickness. In one embodiment, the thickness is one-thirty-second of an inch. This plate creates better contact with the petri dish than would be possible if the dish were placed directly on top of the heating pad. This allows the soil to dry faster due to more efficient heat transfer.

Within the folded lower heating pad, there is a thermocouple sensor. This sensor has wiring that feeds out of the air chamber via the same aperture as those of the heating pads. This allows the thermocouple to attach to a thermocouple Blue Board (e.g., max 6675 module). This module has pins that connect to the SparkFun RedBoard, or the like, allowing thermocouple feedback to determine when the heating pads must be powered in order to maintain a constant temperature. In one embodiment, the temperature is 200 degrees Celsius.

The temperature of the heating pads, as reported by the thermocouple, may be displayed on the LCD on the dryer box. The LCD is attached to the SparkFun RedBoard and reports temperature in degrees Celsius. It is powered by the three 9-volt batteries in parallel, and therefore comes on when the general power switch is flipped to turn on the fan, LCD, and thermocouple, for example. The general power switch and heating pad power switches are lined up together, on the dryer box and next to the LCD.

To use the soil dryer, one turns on the general power switch and wait for the LCD to convey the current temperature in the air chamber, as reported by the thermocouple. Then, the user flips the heater power switch, which will turn on the heating pads to heat to 200 degrees Celsius. Once heated, the vented lid is removed from the front of the box so that a petri dish, or the like, containing a soil sample can be inserted. The vented lid is then returned to the starting position to retain the sample in the air chamber. After two minutes, the sample can be removed from the air chamber, at which point it will have a moisture content of five percent or less. If the heating pads are not warming, the drill battery may be removed from the bottom of the box and recharged or replaced. If the LCD and fan are not powering on, the 9-volt battery charging port on the side of the dryer box may be plugged in to recharge.

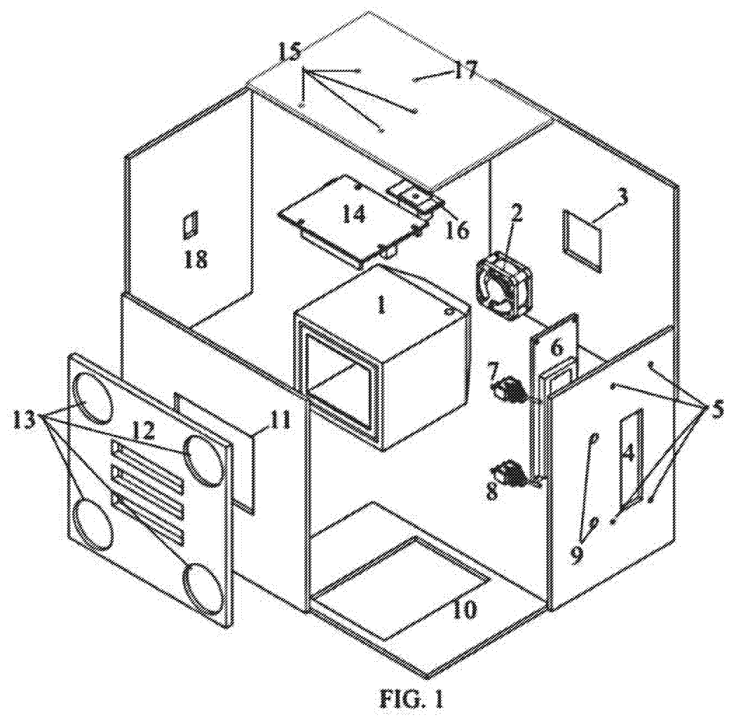

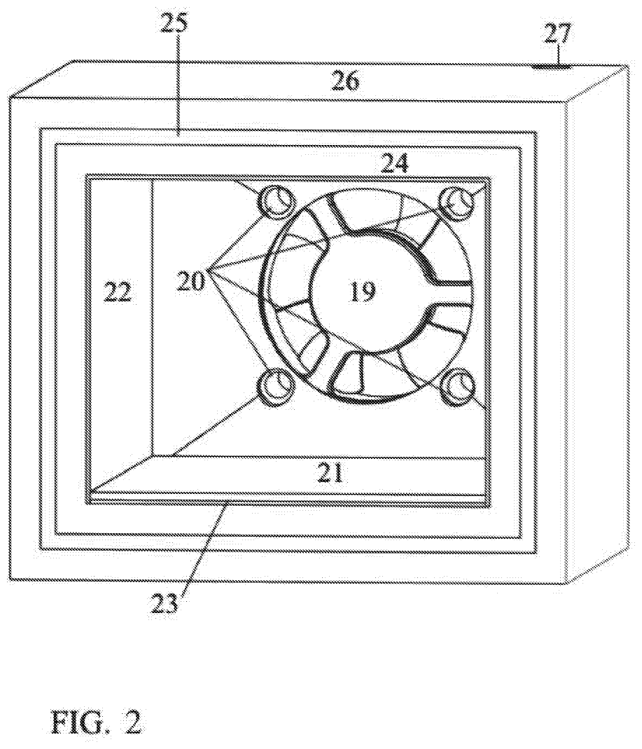

Referring to FIG. 1, an exploded view of one embodiment of a soil dryer of the present disclosure without electrical connections is shown. More specifically, an air chamber 1, into which the petri dish in inserted for drying via heat and air flow (see, e.g., FIG. 2 for more detail) with a fan 2. In one embodiment, the fan runs for 3 out of every 10 seconds, to flush out any evaporated moisture from the air chamber 1. A back of the enclosure 3, has an opening into which the fan 2 fits tightly. An opening in side of the enclosure 4, accommodates an LCD screen 6. A plurality of circular openings 5 in the side of the enclosure, align the LCD via screw holes to secure it in place. The LCD electrical component 6, displays the temperature of a heating pad within the air chamber. A switch 7 controls power to the heating pads that line the air chamber, and a switch 8 controls power to all components but the heating pads (e.g., fan, LCD, SparkFun Red Board). In some embodiments, larger circular openings 9 in the enclosure are provided into which the power and heating switches screw. A bottom of the enclosure 10 is also shown. In this embodiment, there is a machined hole specifically to fit a receptor for a drill battery, or the like. In some embodiments, this hole may be much smaller, simply to allow power connection to battery packs.

Still referring to FIG. 1, a front of the enclosure 11 is shown with an opening that mates with the air chamber 1. This allows for soil sample petri dishes to be inserted and removed from the device, as well as for humidity to be flushed out of the air chamber 1 by the fan 2. In certain embodiments, 3D printed lid 11 comprises vents 12 to allow for humidity to continue to escape from the area, while still preventing most hot air from leaving the chamber. It also keeps petri dishes containing soil samples from sliding out. The vented lid may have indentations on each corner 13, into which a magnet is inserted. In some cases, there are mating magnets secured on the inside of the front of the box so that the lid may be held firmly in place when needed, but is also capable of being easily removed without a risk of losing parts in the field.

In one embodiment, a SparkFun RedBoard, serves as a coded device 14 in the system according to the principles of the present disclosure. Small holes 15 in the top of the enclosure, serve as screw holes to secure the SparkFun RedBoard, or the like. In some cases, a Blue Board (e.g., max 6675 module) 16, connects a thermocouple (senses temperature within the air chamber) and a small hole 17 in the top of the enclosure, serves as a screw hole for securing the max 6675 module, or the like. A final side of the enclosure 18 may comprise a hole for 9V battery charging cables. In certain embodiments, not shown in this figure, on the inside of this wall there could be three 9V batteries connected in parallel. On the outside of the enclosure wall, there would be a charging port for the rechargeable batteries and a hole in the enclosure serves as a way to feed wires to connect the batteries to their charging station.

One embodiment of the soil dryer for the present disclosure had the following dimensions. It is understood that other dimensions and device layouts are within the scope of this disclosure. A device back panel having a fan opening comprising side dimensions of about 146 mm×146 mm, with fan dimensions of about 30 mm×30 mm. In some cases, a 1.6 mm bit is used for manufacture. A device bottom panel having a drill battery fitting comprising side dimensions of about 138 mm×105 mm and a hole dimension of about 62 mm×88 mm. In one embodiment, corners of the hole had a radius of curvature of about 0.2 inches (5 mm). A device front panel having a ventilation opening comprising side dimensions of about 156 mm×156 mm, and hole dimensions of about 65 mm×55 mm. A device first side panel comprising access to 9V Battery cables via a hole having dimensions of about 15 mm×10 mm and the panel having side dimensions of about 138 mm×105 mm. A device second side panel comprising LCD and switches, the panel having side dimensions of about 138 mm×105 mm. In one embodiment, the LCD screen dimensions of about 71 mm×26 mm. A device top panel having a Sparkfun Red Board and Thermocouple Blue Board, or the like, having side dimensions of about 138 mm×105 mm.

Referring to FIG. 2, an axonometric view of one embodiment of an air chamber according to the principles of the present disclosure is shown. More specifically, a fan 19 (same as part 2 in FIG. 1) and holes in the air chamber 20 are shown into which the fan screws into place. In one embodiments, an aluminum plate 21 (e.g., 1/32″) is used, upon which a petri dish sits (acts as a hot plate). In certain embodiments, one or more heating pads 22 wrap around the top and side of the air chamber (e.g., heats to 200° C.) and a heating pad 23 that's folded in half rests beneath the aluminum plate. In one embodiment, the thermocouple is within this heating pad, allowing the temperature to be measured and regulated. Insulation 24 lines the insides of the air chamber 25. In some cases, the air chamber is 3D printed and insulation 26 wraps around the outside of the 3D printed air chamber and a hole 27 extends through both inner and outer insulations, as well as the 3D printed air chamber. This access allows for wires connecting the heating pads and thermocouple to connect to electrical components outside of the chamber and inside of the enclosure.

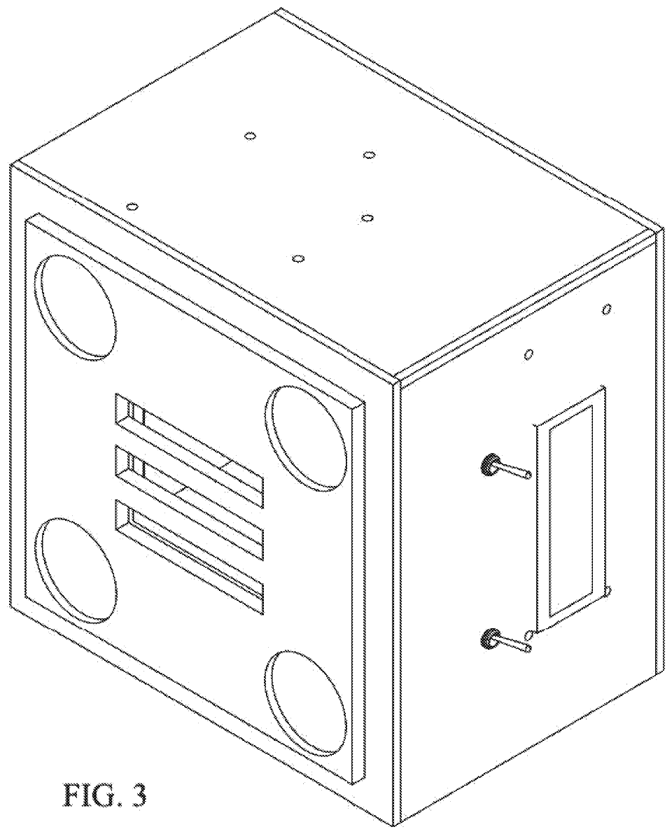

Referring to FIG. 3, a front axonometric view of one embodiment of the soil dryer of the present disclosure is shown. More specifically, a front view of one embodiment of the soil dryer containment box according to the present disclosure shows a 3D printed cover that allows for air blown by the fan on the opposite side of the box (not shown in this figure) to exit the system. This view also shows the second side panel having the LCD display and power switches.

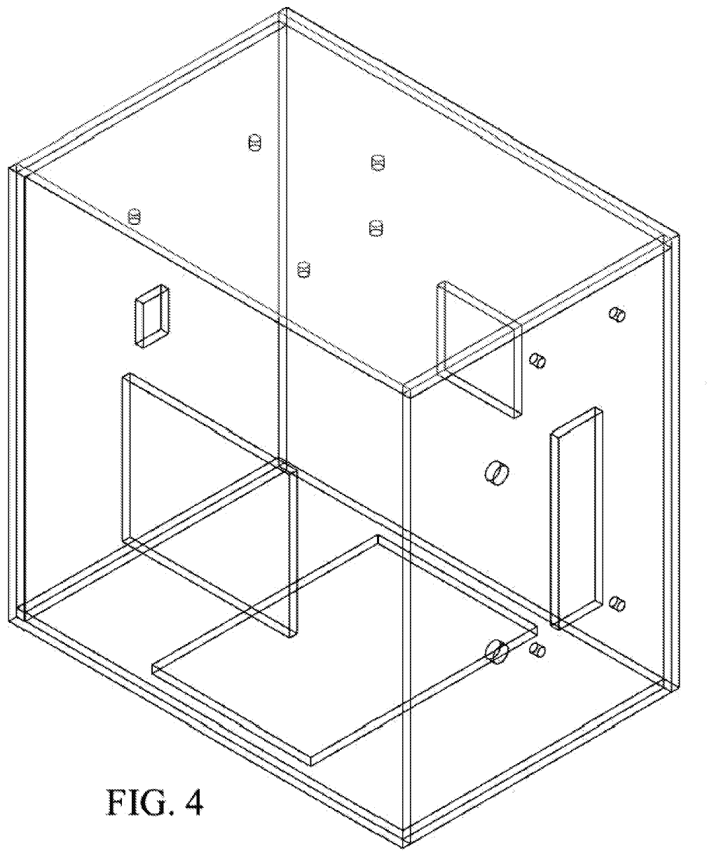

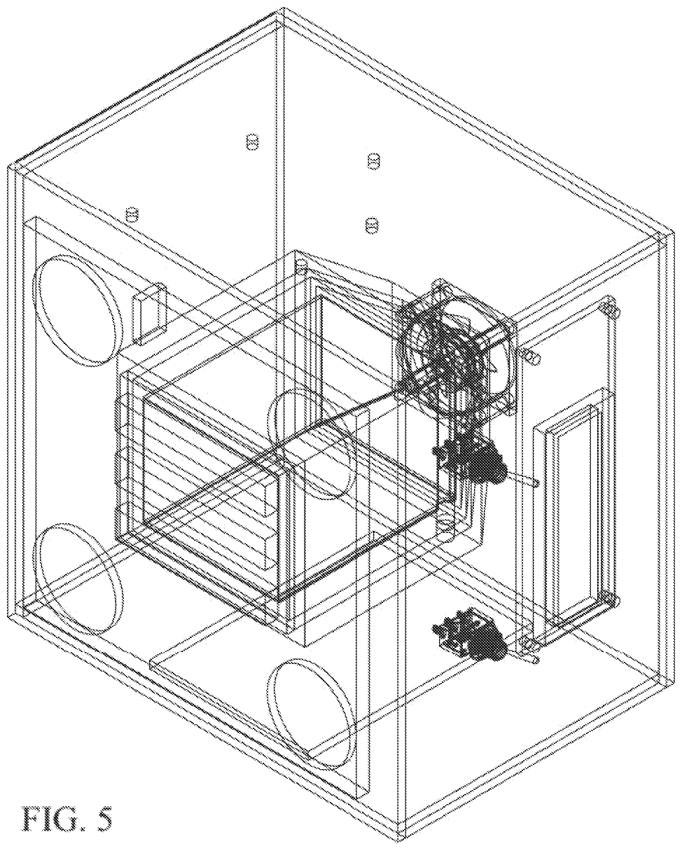

Referring to FIG. 4, a transparent front axonometric view of one embodiment of an enclosure of a soil dryer of the present disclosure is shown. More specifically, this view provides a view of each outer panel of the soil dryer device. Referring to FIG. 5, a transparent front axonometric view of one embodiment of the soil dryer of the present disclosure where a lid, switches, and an air chamber are. More specifically, this figure shows some of the internal features such as the air chamber as well as the fan, the switches and the LCD panel.

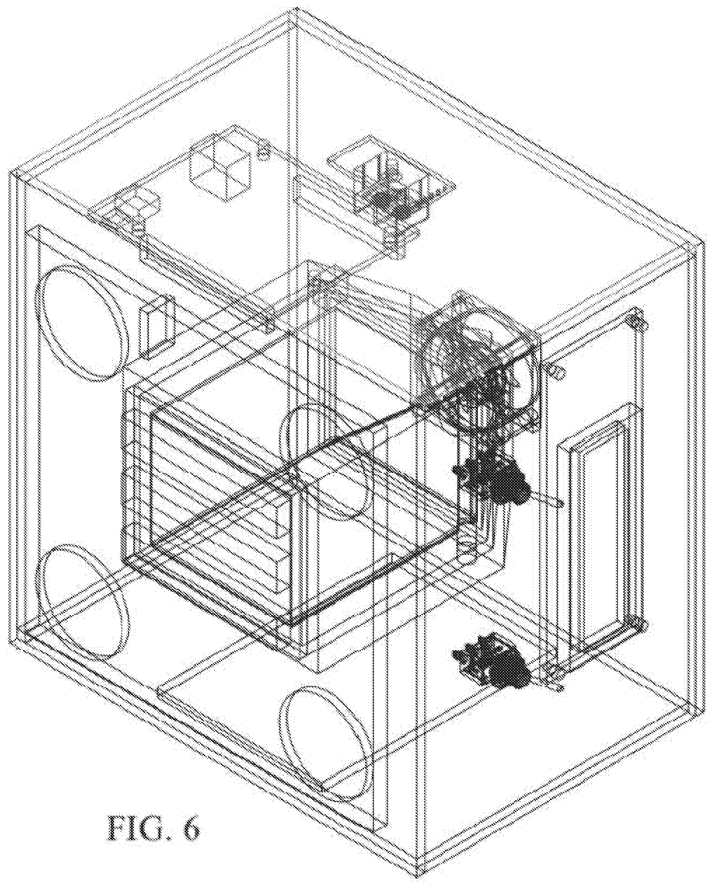

Referring to FIG. 6, a transparent front axonometric view of one embodiment of the soil dryer of the present disclosure as in FIG. 5, with added electronic boards visible is shown. More specifically, in one embodiment to solder to the LCD, a male header is soldered to the display through 16 holes and a female header is then soldered to a PCB breadboard. Wires for the LCD are soldered to corresponding female header pins on the PCB breadboard. After soldering, the male header soldered to the LCD fits into the female header on the PCB breadboard. In one embodiment, the ground (GND −)) is connected to LCD Pin #12 and the power (PWR +) components are soldered to a wire that connects to LCD Pin #15. Further, LCD Pin #3 is soldered to a wire that connects to Sparkfun Digital Pin #2 (Red Board); LCD Pin #4 is soldered to a wire that connects to Sparkfun Digital Pin #3 (Red Board); LCD Pin #5 is soldered to a wire that connects to Sparkfun Digital Pin #4 (Red Board); LCD Pin #6 is soldered to a wire that connects to Sparkfun Digital Pin #5 (Red Board); LCS Pin #7, Pin #8, Pin #9, and Pin #10 are open; LCD Pin #11 is Sparkfun Red Board Digital Pin #11; LCD Pin #12 is soldered to a wire that connects to LCD GND Pin and LCD Pin #16; LCD Pin #13 is soldered to a wire that connects to Sparkfun Red Board Digital Pin #12; LCD Pin #14 is soldered to a wire that connects to a potentiometer Pin #3 (potentiometer Pins #1 & #2=Sparkfun Red Board PWR & GND=5V Pin); LCD Pin #15 is soldered to a wire that connects to LCD PWR+Pin of Sparkfun Red Board 5V Pin; and LCD Pin #16 is soldered to a wire that connects to LCD Pin #12 of Sparkfun Red Board GND Pin. In certain embodiments, the LCD can be replaced with one that requires only 4 connections, rather than 12 as shown here. This substitution requires only minor changes to the Arduino code. Additionally, the potentiometer can be replaced with two resistors. The necessary resistance may vary with different LCDs, so measurements are taken before soldering. In one embodiment, the potentiometer may be replaced with two resistors, having the following connections (although resistances may vary): SparkFun Red Board 5V Pin to 20 MΩ resistor to LCD Pin #14. Pin #14 on the LCD would also connect to a 1.2 kΩ resistor (essentially also putting it in connection with the 20 MΩ resistor), which connects to the power pin on the SparkFun RedBoard.

In one embodiment, wires are not soldered to the Red Board. Instead, a Sparkfun Red Board shield with screw terminals, called an electronics salon uno r3, is used to screw all wires in place. In one embodiment, LCD Pin #3 is soldered to a wire that connects to Digital Pin #2; LCD Pin #4 is soldered to a wire that connects to Digital Pin #3; LCD Pin #5 is soldered to a wire that connects to Digital Pin #4; and LCD Pin #6 is soldered to a wire that connects to Digital Pin #5. Digital Pin #6 is soldered to a wire that connects to a 1 kΩ resistor (to tip 120 base) and Digital Pin #7 is soldered to a wire that connects to a 470Ω resistor (to fan transistor). In one embodiment, Blue Board DO is soldered to a wire that connects to Digital Pin #8; Blue Board CS is soldered to a wire that connects to Digital Pin #9, Blue Board CLK is soldered to a wire that connects to Digital Pin #10; LCD Pin #11 is soldered to a wire that connects to Digital Pin #11. In one embodiment, the GND Pin Bundle—leads to one PCB breadboard with many GND and PWR connections. In one embodiment, AREF, SDA, and SCL can be used for LCD with four connections.

In one embodiment, the GND Pin Bundle comprises a potentiometer Pin (or 1.2 kΩ resistor replacement); LCD Pin #16; Blue Board GND Pin; P2N2222A Amplifier Transistor Emitter; and a Tip 120 Transistor Emitter. In one embodiment, the PWR/5V Pin Bundle comprises a potentiometer Pin (or 20 MΩ resistor replacement); LCD Pin #15; and Blue Board VCC Pin. For connections, a red wire (PWR) provides an outside connection of a power switch and the fan power and a black wire (GND) provides ground of 9V batteries in parallel.

In one embodiment of the soil dryer of the present disclosure, a blue board (e.g., max 6675 module) comprises a thermocouple. Similarly to the LCD, a female header is soldered to a PCB breadboard which then has wire connections soldered to that. The max 6675 module, for example, already has 5 pins, so there is no need to solder a male header to the board. The female header on the PCB board slides directly onto the module's 5 pins. The thermocouple power and ground wires screw into the screw terminals on the other end of the module. In one embodiment, Sparkfun Red Board GND Pin is soldered to a wire that connects to GND; Sparkfun Red Board 5V Pin is soldered to a wire that connects to a VCC and a Thermocouple GND (−x); Sparkfun Red Board Pin #8 is soldered to a wire that connects to DO; Sparkfun Red Board Pin #9 is soldered to a wire that connects to a CS and a Thermocouple PWR (+x); and Sparkfun Red Board Pin #10 is soldered to a wire that connects to a CLK.

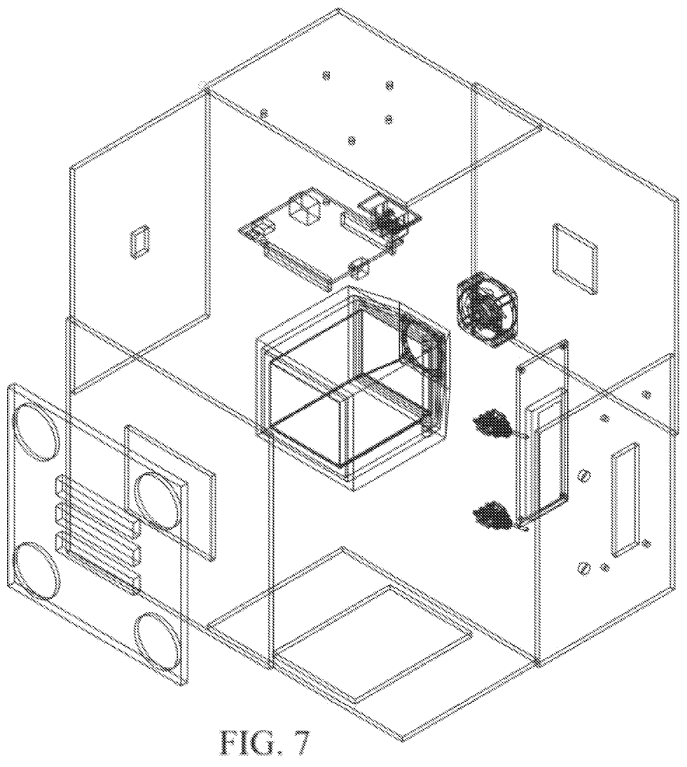

Referring to FIG. 7, an exploded transparent view of one embodiment of a soil dryer of the present disclosure similar to FIG. 1 is shown. More specifically, the internally located air chamber for the soil dryer is depicted. The air chamber is configured to hold a soil sample (not shown). One embodiment of the air chamber is created by a 3D printer and insulated with material similar to bubble wrap on both the inside and outside walls to prevent heat loss. The chamber starts narrow, with four holes into which a fan screws at each corner. The air chamber widens toward the front panel to hold a petri dish containing a five-gram soil sample. The wider end of the air chamber comes into contact with the ventilation side of the box (here the front). The air chamber is lined with the two heating pads, which are programmed to reach two hundred degrees Celsius. There is a small aluminum plate on the bottom of the chamber, onto which the petri dish is placed. The purpose of this plate, with thickness of only one-thirty-second of an inch, for example, is to create better contact between the heating components and the petri dish containing the soil. Within the folded heating pad, there is a thermocouple which monitors the temperature of the heating pads. Finally, there is a hole in the top corner of the chamber, through which the fan and heating pad wires (not shown here) are fed out to the remainder of the electronics.

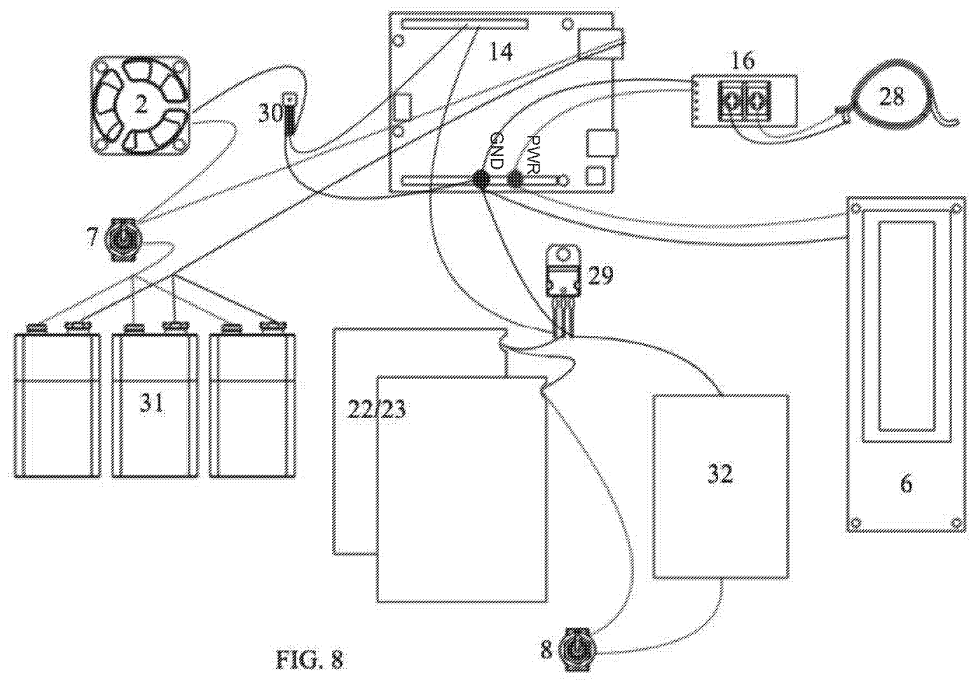

Referring to FIG. 8, a schematic diagram of one embodiment of a soil dryer of the present disclosure with power and ground electrical connections is shown. More specifically, a fan 2 connects to a power switch 7 and 2N amplifier transistor 30. The LCD 6 connects to 5V and ground pins of a SparkFun RedBoard (not shown: connection to pins #2, 3, 4, 5, 11, and 12 on the RedBoard) and the power switch 7 connects to the power of 9V batteries in parallel, the power of fan, and the power cable on SparkFun RedBoard. A heater switch 8 connects to power of two heating pads in series, as well as large battery pack. A SparkFun RedBoard 14 is shown and a blue board 16 screws into the power and ground of thermocouple. Pins connect to 5V and ground pins on SparkFun RedBoard (not shown: pins also connect to RedBoard pins #8, 9, and 10). In one embodiment, two heating pads 22, 23 are connected in series. A thermocouple 28 senses the internal heat of the folded heating pad beneath the aluminum plate (in the air chamber) and connects to the power and ground screws of the blue board. A Tip 120 Transistor 29 connects to a 1 kΩ resistor, which connects to digital pin #6 on the RedBoard, for example. A collector connects to the ground of the heating pads in series and an emitter connects to both the ground of the battery pack and the SparkFun RedBoard ground pin. A 2N Amplifier Transistor 30 is connected to a 470Ω resistor, which connects to the RedBoard digital pin #7. A collector connects to ground of the fan, and the emitter to the ground pin of the SparkFun Redboard. In one embodiment, three 9V Batteries 31 are connected in parallel. Power goes to the power switch 7, ground goes to ground cable on the SparkFun RedBoard 14. In some cases, a battery pack 32 (e.g., a drill battery) connects to the Tip 120 Transistor 29 and heater switch 8.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying FIGS. can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A soil dryer assembly for removing moisture content from soil sampled from a ground, the soil dryer assembly comprising:
a containment box configured to hold and mount dryer mechanical and electrical components;
an air chamber lined with insulation, and attached to a fan at a narrow opening covered by a vented lid at a widened opening, the fan being secured onto the narrow opening of the air chamber;
one or more heating pads regulated by a thermocouple;
an LCD that displays a temperature measured and reported by the thermocouple;
a first power source comprising batteries in parallel, controlled by a general power switch and powering the fan, the LCD, and the thermocouple; and
a second power source comprising another battery to power the one or more heating pads lining the inner air chamber.

2. The soil dryer assembly of claim 1, wherein a user dries a sample of soil to a moisture content of five percent or less at the site of sampling.

3. The soil dryer assembly of claim 1, wherein insulation is inside and outside of the air chamber.

4. The soil dryer assembly of claim 1, wherein the vented lid is held in place by magnets.

5. The soil dryer assembly of claim 1, wherein the air chamber is configured to fit a soil sample in a Petri dish.

6. The soil dryer assembly of claim 1, wherein a heat conducting plate is used to support the soil sample in the air chamber and provide for even heating of the sample.

7. The soil dryer assembly of claim 1, wherein the heating pads are coded to reach about 200 degrees Celsius.

8. The soil dryer assembly of claim 1, wherein the first power source is 3 9V batteries.

9. A method for removing moisture content from soil sampled from a ground, the method comprising:
providing a soil drying device comprising:
a containment box configured to hold and mount dryer mechanical and electrical components;
an air chamber lined with insulation, and attached to a fan at a first opening covered by a vented lid at a second opening, the fan being secured onto the first opening of the air chamber;
one or more heating pads regulated by a thermocouple;
an LCD that displays a temperature measured and reported by the thermocouple;
a first power source comprising batteries in parallel, controlled by a general power switch and powering the fan, the LCD, and the thermocouple; and
a second power source comprising another battery to power the one or more heating pads lining the inner air chamber;
switching on the general power and a heater switch;
waiting for the temperature in the air chamber to reach a threshold temperature;
removing the vented lid and placing a soil sample inside the air chamber;
replacing the vented air lid;
waiting for a time period in minutes; and
removing the sample for further analysis, wherein the moisture content of the sample is five percent or less at the site of sampling.

10. The method of claim 9, wherein insulation is inside and outside of the air chamber.

11. The method of claim 9, wherein the vented lid is held in place by magnets.

12. The method of claim 9, wherein the air chamber is configured to fit a soil sample in a Petri dish.

13. The method of claim 9, wherein a heat conducting plate is used to support the soil sample in the air chamber and provide for even heating of the sample.

14. The method claim 9, wherein the heating pads are coded to reach about 200 degrees Celsius.

15. The method of claim 9, wherein the first power source is 3 9V batteries, and the second power source is a drill battery.

16. The method of claim 9, wherein second power source is a higher voltage than the first power source which is portable and rechargeable source and powers only the heating pads.
